(19) United States
(12) Patent Application Publication
(10) Pub. No.: US 2023/0278101 A1
(43) Pub. Date: Sep. 7, 2023

(54) THREE-DIMENSIONAL PRINTING KITS

(71) Applicant: Hewlett-Packard Development Company, L.P., Spring, TX (US)

(72) Inventors: VLADEK KASPERCHIK, CORVALLIS, OR (US); NATALIE HARVEY, CORVALLIS, OR (US); MICHAEL G MONROE, CORVALLIS, OR (US)

(73) Assignee: Hewlett-Packard Development Company, L.P., Spring, TX (US)

(21) Appl. No.: 18/008,390

(22) PCT Filed: Jul. 1, 2020
(86) PCT No.: PCT/US2020/040413

§ 371 Date: Dec. 5, 2022

(51) Int. Cl. B22F 10/14; B22F 10/64; B33Y 10/00; B33Y 70/10

(52) U.S. Cl. CPC B22F 10/14; B22F 10/64; B33Y 10/00; B33Y 70/10; B22F 2301/35

(57) ABSTRACT

A three-dimensional printing kit can include a binding agent and a particulate build material. The binding agent can include a binder in an aqueous liquid vehicle. The aqueous liquid vehicle can include an organic co-solvent with a boiling point from about 150° C. to about 300° C. The particulate build material can include from about 80 wt % to 100 wt % stainless steel particles that can have an average particle size from about 3 μm to about 200 μm. About 0.02 wt % to about 0.3 wt % of a total weight of the stainless steel particles can be an oxidation barrier formed on surfaces of the stainless steel particles.

### BACKGROUND

Three-dimensional printing may be an additive printing process used to make three-dimensional solid parts from a digital model. Three-dimensional printing is often used in rapid product prototyping, mold generation, mold master generation, and short run manufacturing. Some three-dimensional printing techniques are considered additive processes because they involve the application of successive layers of material. This is unlike other machining processes, which often rely upon the removal of material to create the final part. Some three-dimensional printing methods use chemical binders or adhesives to bind build materials together. Other three-dimensional printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 schematically illustrates an example three-dimensional printing kit in accordance with the present disclosure;

FIG. 2 is a flow diagram illustrating an example method of three-dimensional printing in accordance with the present disclosure;

FIG. 3 is a flow diagram illustrating a method of preparing a build material for three-dimensional printing in accordance with the present disclosure;

FIG. 4A schematically illustrates an example system for three-dimensional printing in accordance with the present disclosure;

FIG. 4B schematically illustrates an example system for three-dimensional printing in accordance with the present disclosure;

FIG. 5 graphically illustrates temperature vs. weight gain of stainless steel particles in accordance with an example of the present disclosure; and

FIG. 6 graphically illustrates temperature vs. weight gain of stainless steel particles in accordance with an example of the present disclosure.

### DETAILED DESCRIPTION

Three-dimensional printing can be an additive process that can involve the application of successive layers of particulate build material with chemical binders or adhesives printed thereon to bind the successive layers of the particulate build materials together. In some processes, application of a binding agent with a binder therein can be utilized to form a green body object and then a fused three-dimensional physical object can be formed therefrom. More specifically, binding agent can be selectively applied to a layer of a particulate build material on a support bed to pattern a selected region of the layer of the particulate build material and then another layer of the particulate build material is applied thereon. The binding agent can be applied to another layer of the particulate build material and these processes can be repeated to form a green part (also known as a three-dimensional green body or object), which can then be heat fused to form a sintered three-dimensional object.

Three-dimensional printing with stainless steel particles can have unique challenges due to the latent catalytical properties of these particles. Printing vapors can evaporate off of the organic co-solvent which can interact with the stainless steel particles. Decomposition of the organic co-solvent and repolymerization with a surface of the stainless steel particles can cause an organic adhesive to form on a surface of the stainless steel particles. The organic adhesive can cause stainless steel particles to stick together in undesired locations, which can result in the formation of powder cake(s) at non-printed portions of the powder bed. The powder cake(s) can make it difficult to remove green body objects from the powder bed. In addition, the powder cakes(s) may also cling to green body objects compromising dimensional control of three-dimensional printed objects. Removal of powder cake(s) from a green body object surface may also result in damage to the green body object.

In accordance with this, in one example, a three-dimensional printing kit can include a binding agent and a particulate build material. The binding agent can include a binder dispersed in an aqueous liquid vehicle. The aqueous liquid vehicle can include an organic co-solvent with a boiling point from about 150° C. to about 300° C. The particulate build material can include from about 80 wt % to 100 wt % stainless steel particles that can have an average particle size from about 3 μm to about 200 μm, for example. About 0.02 wt % to about 0.3 wt % of a total weight of the stainless steel particles can be an oxidation barrier formed on surfaces of the stainless steel particles. In one example, the organic co-solvent can be a polyol, an oligoglycol, or a lactam. In another example, the organic co-solvent can be selected from diols; 1,2 butanediol; 1,2-propanediol; 2,3-butanediol; 1,2-pentanediol; 2-methyl-2,4-pentanediol; 2-methyl-1,3-propanediol; triols; tetrahydrofuran; ethylene glycol dimethyl ether; ethylene glycol diethylene glycol; triethylene glycol; propylene glycol; tripropylene glycol butyl ether; lactams; 2-pyrrolidone; 1-(2-hydroxyl)-2-pyrrolidone; or a combination thereof. In yet another example, the organic co-solvent can be present in the aqueous liquid vehicle at from about 5 wt % to about 50 wt %. In one example, the stainless steel particles can be austenitic stainless steel particles. In another example, a carbon content of the stainless steel particles can range from about 0.001 wt % to about 0.1 wt %. In yet another example, the oxidation barrier can be a layer selected from a Fe₂O₃, Fe₃O₄FeO, Cr₂O₃, Ni₂O₃, Mn₂O₃, oxides thereof, complex oxides thereof, or combinations thereof. In a further example, the oxidation barrier can have an average thickness from about 3 nm to about 30 nm.

In another example, a method of three-dimensional printing is presented. The method can include iteratively applying individual build material layers of a particulate build material onto a powder bed. The particulate build material can include from about 80 wt % to 100 wt % stainless steel particles having an average particle size from about 3 μm to about 200 μm and from about 0.02 wt % to about 0.3 wt % of a total weight of the stainless steel particles can be an oxidation barrier formed on surfaces of the stainless steel particles. The method can further include, based on a three-dimensional object model, iteratively and selectively applying a binding agent to the individual build material layers to define individually patterned object layers that can become adhered to one another to form a layered green body object. The binding agent can include a binder dispersed in an aqueous liquid vehicle. The aqueous liquid vehicle can include an organic co-solvent with a boiling point ranging from about 150° C. to about 300° C. In one example, the method can further include preheating stainless steel particles to a temperature ranging from about 150° C. to about 300° C. for a time period ranging from about 2 hours to about 15 hours to form the oxidation barrier on surfaces of the stainless steel particles. In another example, the method can further include heating the layered green body object to a temperature ranging from about 600° C. to about 1,500° C. to fuse the green body object together to form a fused three-dimensional object. In yet another example, the organic co-solvent can include 1,2 butanediol. In a further example, the oxidation barrier can have an average thickness of from about 3 nm to about 30 nm.

In another example, a method of preparing a build material for three-dimensional printing can include heating stainless steel particles to a temperature ranging from about 150° C. to about 300° C. for a time period ranging from about 2 hours to about 15 hours to form an oxidation barrier on a surface of the stainless steel particles. In one example, the oxidation barrier formed on the surface of the stainless steel particles can be from about 0.05 wt % to about 0.3 wt % of a total weight of the stainless steel particles.

When discussing the three-dimensional printing kit, the method of three-dimensional printing, and/or the method of preparing a build material for three-dimensional printing herein, these discussions can be considered applicable to one another whether or not they are explicitly discussed in the context of that example. Thus, for example, when discussing a stainless steel particle related to a three-dimensional printing kit, such disclosure is also relevant to and directly supported in the context of the method of three-dimensional printing, the method of preparing a build material for three-dimensional printing, and vice versa.

Terms used herein will have the ordinary meaning in the relevant technical field unless specified otherwise. In some instances, there are terms defined more specifically throughout the specification or included at the end of the present specification, and thus, these terms can have a meaning as described herein.

### Three-Dimensional Printing Kits

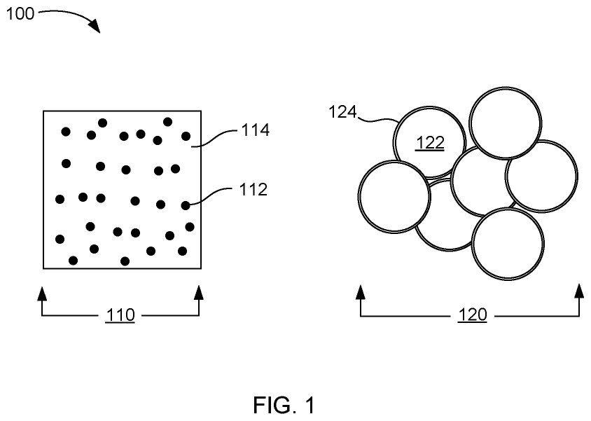

In accordance with examples of the present disclosure, a three-dimensional printing kit 100 is shown in FIG. 1. The three-dimensional printing kit can include a binding agent 110 and a particulate build material 120. The binding agent can include a binder 112 in an aqueous liquid vehicle 114. The aqueous liquid vehicle can include an organic co-solvent with a boiling point from about 150° C. to about 300° C. The particulate build material can include, by way of example, from about 80 wt % to 100 wt % stainless steel particles 122 that can have a D50 particle size from about 3 μm to about 200 μm. From about 0.02 wt % to about 0.3 wt % of a total weight of the stainless particles can be an oxidation barrier 124 formed on surfaces of the stainless steel particles. The binding agent, may be packaged or co-packaged with the particulate build material in separate containers, and/or the particulate build material of the three-dimensional printing kit can be generated by treating a stainless steel particle prior to application of the binding agent.

### Binding Agents

In further detail regarding the binding agent that may be present in the three-dimensional printing kit or utilized in a method of three-dimensional printing as described herein, the binding agent can include an aqueous liquid vehicle and binder, e.g., latex particles, to bind the particulate build material together during the build process to form a three-dimensional green body object. The term “binder” can include material used to physically bind separate metal particles together or facilitate adhesion to a surface of adjacent metal particles to a green part or three-dimensional green body object in preparation for subsequent fusing, sintering, or annealing. During three-dimensional printing, a binding agent can be applied to the particulate build material on a layer by layer basis and can move into vacant spaces between particles of the particulate build material. The binding agent can provide binding to the particulate build material upon application, or in some instances, can be further treated after printing to provide binding properties, e.g., exposure to IR energy to evaporate volatile species, exposure to flash heating (photo energy and heat) to activate a reducing agent, exposure to UV or IR energy to initiate polymerization, and the like.

A “green” body object, green part, three-dimensional green body object or individual patterned layer can refer to any component or mixture of components that are not yet sintered or annealed. “Sintering” refers to the consolidation and physical bonding of the metal particles together (after temporary binding using the binding agent) by solid state diffusion bonding, partial melting of metal particles or a combination of solid state diffusion bonding and partial melting. The term “anneal” refers to a heating and cooling sequence that controls the heating process and the cooling process, e.g., slowing cooling in some instances to remove internal stresses and/or toughen the sintered part or object (or “brown” part) prepared in accordance with examples of the present disclosure.

In one example, the binder can be a polymer binder or a polymerizable binder. In one example, the binder may be present at from about 2 wt % to about 50 wt %, from about 10 wt % to about 25 wt %, from about 3 wt % to about 20 wt %, from about 5 wt % to about 15 wt %, from about 25 wt % to about 50 wt %, from about 20 wt % to about 40 wt %, or from about 5 wt % to about 20 wt % in the binding agent.

In some examples, the binder can include latex particles. The latex particles can have a D50 particle size that can range from about 10 μm to about 250 μm and can be dispersed in the aqueous liquid vehicle. The latex particles can include polymerized monomers of vinyl, vinyl chloride, vinylidene chloride, vinyl ester, functional vinyl monomers, acrylate, acrylic, acrylic acid, hydroxyethyl acrylate, methacrylate, methacrylic acid, styrene, substituted methyl styrenes, ethylene, maleate esters, fumarate esters, itaconate esters, α-methyl styrene, p-methyl styrene, methyl (meth)acrylate, hexyl acrylate, hexyl (meth)acrylate, butyl acrylate, butyl (meth)acrylate, ethyl acrylate, ethyl (meth)acrylate, propyl acrylate, propyl (meth)acrylate, 2-ethylhexyl acrylate, 2-ethylhexyl (meth)acrylate, isodecyl (meth) acrylate, octadecyl acrylate, octadecyl (meth)acrylate, stearyl (meth)acrylate, vinylbenzyl chloride, isobornyl acrylate, isobornyl (meth)acrylate, tetrahydrofurfuryl acrylate, tetrahydrofurfuryl (meth)acrylate, 2-phenoxyethyl (meth)acrylate, benzyl (meth)acrylate, benzyl acrylate, ethoxylated nonyl phenol (meth)acrylate, isobornyl (meth)acrylate, cyclohexyl (meth)acrylate, trimethyl cyclohexyl (meth)acrylate, t-butyl (meth)acrylate, n-octyl (meth)acrylate, lauryl (meth)acrylate, tridecyl (meth)acrylate, alkoxylated tetrahydrofurfuryl acrylate, alkoxylated tetrahydrofurfuryl (meth)acrylate, isodecyl acrylate, isobornyl methacrylate, isobornyl acrylate, dimethyl maleate, dioctyl maleate, acetoacetoxyethyl (meth)acrylate, diacetone acrylamide, diacetone (meth)acrylamide, N-vinyl imidazole, N-vinylcarbazole, N-vinyl-caprolactam, combinations thereof, derivatives thereof, or mixtures thereof.

In other examples, the latex particles can include acidic monomers that can be polymerized such as acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, sodium 1-allyloxy-2-hydroxypropane sulfonate, combinations thereof, derivatives thereof, or mixtures thereof.

In some examples, the latex particles can include an acrylic. In other examples, the latex particles can include 2-phenoxyethyl methacrylate, cyclohexyl methacrylate, cyclohexyl acrylate, methacrylic acid, combinations thereof, derivatives thereof, or mixtures thereof. In yet another example, the latex particles can include styrene, methyl methacrylate, butyl acrylate, methacrylic acid, combinations thereof, derivatives thereof, or mixtures thereof.

The binder can be dispersed in an aqueous liquid vehicle suitable for jetting. In one example, the aqueous liquid vehicle, can include water as a major solvent, e.g., the solvent present at the highest concentration when compared to other co-solvents. The aqueous liquid vehicle can be present in the binding agent at from about 20 wt % to about 98 wt %, from about 70 wt % to about 98 wt %, from about 50 wt % to about 90 wt %, or from about 25 wt % to about 75 wt %, based on a total weight of the binding agent.

Apart from water, the aqueous liquid vehicle further includes an organic co-solvent having a boiling point from about 150° C. to about 300° C. In yet other examples, a boiling point of the organic co-solvent can range from about 160° C. to about 300° C., from about 180° C. to about 300° C., or from about 200° C. to about 280° C. The organic co-solvent may act as a humectant preventing printheads from drying. The organic co-solvent may also act as a coalescing solvent which, in conjunction with the binder, can provide binding to the particulate build material.

In some examples, the organic co-solvent can be selected from a polyol, an oligoglycol, or a lactam. In another example, the organic co-solvent can be a polyol. In one example, the organic co-solvent can be selected from diols; 1,2 butanediol; 1,2-propanediol; 2,3-butanediol; 1,2-pentanediol; 2-methyl-2,4-pentanediol; 2-methyl-1,3-propanediol; triols; tetrahydrofuran; ethylene glycol dimethyl ether; ethylene glycol diethylene glycol; triethylene glycol; propylene glycol; tripropylene glycol butyl ether; lactams; 2-pyrrolidone; 1-(2-hydroxyl)-2-pyrrolidone; or a combination thereof. In another example, the organic co-solvent can be a diol and the diol can be selected from 1,2 butanediol; 1,2-propanediol; 2,3-butanediol; 1,2-pentanediol; 2-methyl-2,4-pentanediol; 2-methyl-1,3-propanediol; or a combination thereof. In yet another example, the organic co-solvent can be 1,2 butanediol.

The organic co-solvent can be present in the aqueous liquid vehicle at from about 5 wt % to about 50 wt %, from about 6 wt % to about 30 wt %, from about 15 wt % to about 30 wt %, from about 20 wt % to about 40 wt %, or from about 10 wt % to about 20 wt %, based on a total weight of the binding agent.

In yet other examples, the aqueous liquid vehicle can include from about 0.1 wt % to about 50 wt % of other liquid components based on a total weight of the binding agent. The other liquid components can include surfactants, additives that inhibit growth of harmful microorganisms, pH adjusters, viscosity modifiers, sequestering agents, preservatives, etc.

The aqueous liquid vehicle may include surfactant. The surfactant can include a non-ionic surfactant, a cationic surfactant, and/or an anionic surfactant. Example non-ionic surfactants can include self-emulsifiable, nonionic wetting agents based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant can be an ethoxylated low-foam wetting agent (e.g., SURFYNOL® 440, SURFYNOL® 465, or SURFYNOL® CT-111 from Air Products and Chemical Inc., USA), or an ethoxylated wetting agent and molecular defoamer (e.g., SURFYNOL® 420 from Air Products and Chemical Inc., USA). Still other examples of surfactants can include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 15S7, and TERGITOL® 15S9 from The Dow Chemical Company, USA), or a combination thereof. In other examples, the surfactant can include non-ionic organic surfactants (e.g., TEGO® Wet 510 from Evonik Industries AG, Germany), a non-ionic secondary alcohol ethoxylate (e.g., TERGITOL® 15-S-5, TERGITOL® 15-S-7, TERGITOL® 15-S-9, and TERGITOL® 15-S-30 all from Dow Chemical Company, USA), or a combination thereof. Example anionic surfactants can include alkyldiphenyloxide disulfonate (e.g., DOWFAX® 8390 and DOWFAX® 2A1 from The Dow Chemical Company, USA), and oleth-3 phosphate surfactant (e.g., CRODAFOS™ N3 Acid from Croda, UK). Example cationic surfactant can include dodecyltrimethylammonium chloride, hexadecyldimethylammonium chloride, or a combination thereof. In some examples, the surfactant can include a co-polymerizable surfactant. Co-polymerizable surfactants can include polyoxyethylene alkylphenyl ether ammonium sulfate, sodium polyoxyethylene alkylether sulfuric ester, polyoxyethylene styrenated phenyl ether ammonium sulfate, or mixtures thereof. In some examples, the surfactant (which may be a blend of multiple surfactants) may be present in the binding agent at an amount ranging from 0.01 wt % to 2 wt %, from 0.05 wt % to 1.5 wt %, or from 0.01 wt % to 1 wt %.

Some example additives that can inhibit the growth of harmful microorganisms can include biocides, fungicides, and other microbial agents. Example antimicrobial agents can include the NUOSEPr (Ashland Inc., USA), VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT® 250-T, (Lonza Ltd. Corp., Switzerland), KORDEK® MLX (The Dow Chemical Co., USA), and combinations thereof. In an example, if included, a total amount of antimicrobial agents in the binding agent can range from 0.01 wt % to 1 wt %.

In some examples, an aqueous liquid vehicle may further include a buffer. The buffer can withstand small changes (e.g., less than 1) in pH when small quantities of a water-soluble acid or a water-soluble base are added to a composition containing the buffer. The buffer can have pH ranges from 5 to 9.5, from 7 to 9, or from 7.5 to 8.5. In some examples, the buffer can include a poly-hydroxy functional amine. In other examples, the buffer can include potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N, N, N′N′-tetrakis-(2-hydroxyethyl)-ethylenediamine and N,N,N′N′-tetrakis-(2-hydroxypropyl)-ethylenediamine, beta-alanine, betaine, or mixtures thereof. In yet other examples, the buffer can include 2-amino-2-(hydroxymethyl)-1,3-propanediol (TRIZMA sold by Sigma-Aldrich, USA), beta-alanine, betaine, or mixtures thereof.

When applied to a layer of the particulate build material, the aqueous liquid vehicle can be capable of wetting the particulate build material and the binder can be capable of penetrating into microscopic pores of the layer (e.g. the spaces between the stainless steel particles of the particulate build material). The binder can be activated or cured by heating the binder, (which may be accomplished by heating an entire layer of the particulate build material on at least a portion of which the binding agent has been selectively applied) to about the glass transition temperature of the binder. When activated or cured, the binding agent can form an at least substantially continuous network gluing the stainless steel particles of the particulate build material together and can form a three-dimensional green body object or a printed layer of the three-dimensional green body object. The three-dimensional green body object can have the mechanical strength to withstand extraction from a powder bed and can be sintered or annealed to form a three-dimensional printed object. In some examples, the binder contained in the binding agent can undergo a pyrolysis or burnout process where the binder may be removed during sintering or annealing. This can occur where the thermal energy applied to a three-dimensional green body part or object removes inorganic or organic volatiles and/or other materials that may be present either by decomposition or by burning the binding agent.

### Particulate Build Materials

The particulate build material can include from about 80 wt % to 100 wt % stainless steel particles based on a total weight of the particulate build material. In other examples, the powder bed material can include from about 90 wt % to 100 wt % stainless steel particles, from about 99 wt % to 100 wt % stainless steel particles, or can consist of the stainless steel particles, e.g., 100 wt % stainless steel particles. The stainless steel particles can include a core material with an oxidation barrier formed on a surface thereof.

The stainless steel particles can include austenitic, ferritic, martensitic, duplex, or precipitation hardening steels. In one example, the stainless steel particles can include austenitic steels, ferritic steels, a combination, or a mixture thereof. In another example, the stainless steel particles can be austenitic steels. In some examples, the stainless steel particles can be low carbon content stainless steels. For example, a carbon content of the stainless steel can range from about 0.001 wt % to about 0.1 wt %, from about 0.001 wt % to about 0.03 wt %, or from about 0.03 wt % to about 0.1 wt %.

A core of the stainless steel particles can have an average particle size of from about 2.997 μm to about 199.997 μm, having a total average particle size (including the oxidation barrier) of about 3 μm to about 200 μm. In yet other examples, the core can have an average particle size of from about 2.997 μm to about 50 μm, from about 10 μm to about 150 μm, from about 2.997 μm to about 15 μm, from about 2.997 μm to about 25 μm, or from about 50 μm to about 150 μm.

As used herein, particle size can refer to a value of the diameter of spherical particles or in particles that are not spherical can refer to the equivalent spherical diameter of that particle. The particle size can be presented as a Gaussian distribution or a Gaussian-like distribution (or normal or normal-like distribution). Gaussian-like distributions are distribution curves that can appear Gaussian in distribution curve shape, but which can be slightly skewed in one direction or the other (toward the smaller end or toward the larger end of the particle size distribution range). That being stated, an example Gaussian-like distribution of the metal particles can be characterized generally using “D10,” “D50,” and “D90” particle size distribution values, where D10 refers to the particle size at the 10th percentile, D50 refers to the particle size at the 50th percentile, and D90 refers to the particle size at the 90th percentile. For example, a D50 value of about 25 μm means that about 50% of the particles (by number) have a particle size greater than about 25 μm and about 50% of the particles have a particle size less than about 25 μm. Particle size distribution values are not necessarily related to Gaussian distribution curves. In practice, true Gaussian distributions are not typically present, as some skewing can be present, but still, the Gaussian-like distribution can be considered to be “Gaussian” as used in practice. Particle size distribution here is typically expressed in terms of D50 particle size, which can approximate average particle size, but may not be the same. In examples herein, the particle size ranges herein can be modified to “average particle size,” providing sometimes slightly different size distribution ranges.

The core can have an oxidation barrier formed on a surface thereof. The oxidation barrier can be a layer selected from a Fe₂O₃, Fe₃O₄FeO, Cr₂O₃, Ni₂O₃, Mn₂O₃, oxides thereof, complex oxides thereof, or combinations thereof. In another example, the oxidation barrier can be a layer of Fe₂O₃ or Fe₃O₄FeO. In yet another example, the oxidation barrier can be a layer of Fe₂O₃, Cr₂O₃, Ni₂O₃, or Mn₂O₃.

The oxidation barrier can be from about 0.02 wt % to about 0.5 wt % of a total weight of the stainless steel particles. In yet other examples, the oxidation barrier can be from about 0.02 wt % to about 0.1 wt %, from about 0.05 wt % to about 0.3 wt %, from about 0.05 wt % to about 0.2 wt %, or from about 0.02 wt % to about 0.2 wt % of a total weight of the stainless steel particles.

In some examples, the oxidation barrier can have an average thickness of from about 3 nm to about 30 nm. In some examples, the oxidation barrier can have an average thickness of from about 5 nm to about 25 nm, from about 10 nm to about 30 nm, from about 15 nm to about 25 nm, or from about 3 nm to about 15 nm. In some examples, the oxidation barrier can be a stable layer and the average thickness can be a stable average thickness. As used herein, “stable average thickness” indicates that the oxidation barrier does not grow in thickness more than about 1% when exposed to air having a humidity of about 25% at a temperature of about 200° C. for a time period of about 24 hours. Lower humidity levels and/or lower temperatures would also not cause the oxidation barrier to grow more than 1% in thickness, and thus, the 25% humidity and 200° C. temperature is used to define the outer limits of determining whether the oxidation barrier has a “stable average thickness.”

In some examples, the oxidation barrier can prevent or reduce moisture and outside chemicals from interacting with a material of the core of the stainless steel particles. In some examples, the oxidation barrier can be an adherent layer. As used herein, an “adherent layer” indicates that the oxidation barrier can be physically, chemically, or physically and chemically bonded to the core. In some examples, the oxidation barrier can be uniform, impervious, and adherent and can thereby prevent or reduce moisture or chemicals from reaching the core.

The shape of the stainless steel particles can be spherical, irregular spherical, rounded, semi-rounded, discoidal, angular, subangular, cubic, cylindrical, or any combination thereof. In one example, the stainless steel particles can include spherical particles, irregular spherical particles, or rounded particles. In some examples, the shape of the stainless steel particles can be uniform or substantially uniform, which can allow for relatively uniform melting or sintering of the stainless steel particulates after the three-dimensional green part can be formed and then heat fused in a sintering or annealing oven, for example.

### Three-Dimensional Printing Methods

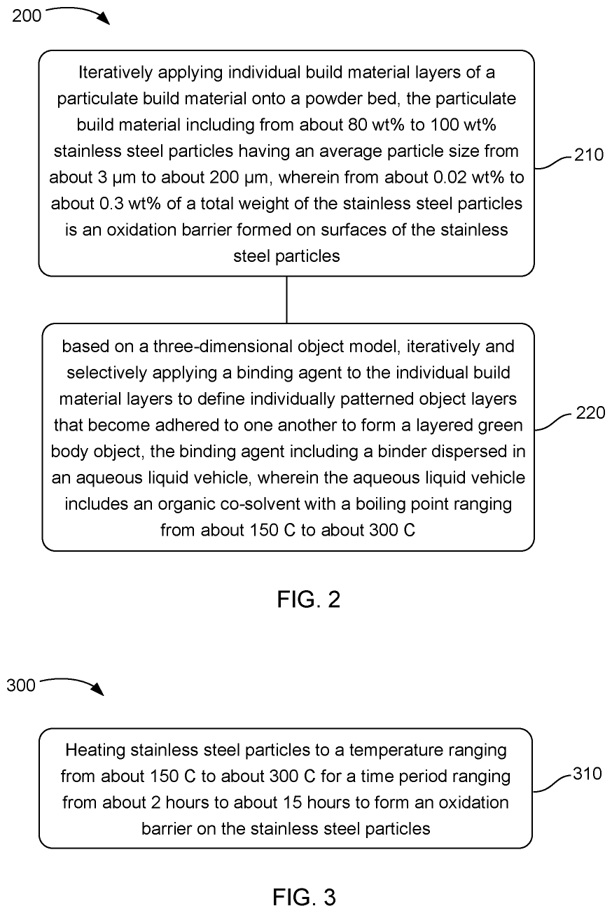

A flow diagram of an example method of three-dimensional printing 200 is shown in FIG. 2. The method can include iteratively applying 210 individual build material layers of a particulate build material onto a powder bed. The particulate build material can include from about 80 wt % to 100 wt % stainless steel particles that can have an average particle size from about 3 μm to about 200 μm. Individual stainless steel particles can include a core with an oxidation barrier formed thereon. The oxidation barrier can be from about 0.05 wt % to about 0.3 wt % of a total weight of the stainless steel particles and can be formed on a surface of the core of the stainless steel particles. The method can further include, based on a three-dimensional object model, iteratively and selectively applying 220 a binding agent to individual build material layers to define individually patterned object layers that can become adhered to one another to form a layered green body object. The binding agent can include a binder dispersed in an aqueous liquid vehicle. The aqueous liquid vehicle can include an organic co-solvent with a boiling point ranging from about 150° C. to about 300° C.

After an individual particulate build material layer is printed with a binding agent, in some instances the individual build material layer can be heated to drive off water and/or other liquid vehicle components and to further solidify the layer of the three-dimensional green body object. The build platform can be dropped a distance of (x), which can correspond to the thickness of a printed layer of the three-dimensional green body object, so that another layer of the particulate build material can be added thereon, printed with binding agent, solidified, etc. The process can be repeated on a layer by layer basis until the entire three-dimensional green body object is formed and stable enough to move to an oven suitable for fusing, e.g., sintering, annealing, melting, or the like.

In some examples, heat can be applied to the individual build material layers (or group of layers) with a binding agent printed thereon to drive off water and/or other liquid vehicle components from the binding agent and to further solidify the individual build material layers of the three-dimensional green body object. In one example, heat can be applied from overhead and/or can be provided by the build platform from beneath the particulate build material. In some examples, the particulate build material can be heated prior to dispensing. Further, heating can occur upon application of the binding agent to the individual build material layers or following application of the printed binding agent. The temperature(s) at which the metal particles of the particulate build material fuse together can be above the temperature of the environment in which the patterning portion of the three-dimensional printing method is performed, e.g., patterning at from about 18° C. to about 100° C. and fusing/debinding/sintering at from about 300° C. to about 1,500° C. In some examples, the metal particles of the particulate build material can have a melting point ranging from about 600° C. to about 1,800° C.

Following the formation of the three-dimensional green body object, the entire three-dimensional green body object can be moved to an oven and heated to a temperature ranging from about 600° C. to about 1,500° C. to fuse the metal particles together and to form a sintered three-dimensional object. In some examples, the temperature can range from about 600° C. to about 1,200° C., from about 800° C. to about 1,200° C., or from about 750° C. to about 1,500° C. Depending on the build material particles, these temperature ranges can be used to melt an outer layer of the build material particles and can permit sintering of the build material particles to one another, while not melting an inner portion of the metal particles, in one example.

The eventual sintering temperature range can vary, depending on the particle size, but in one example, the sintering temperature can range from about 10° C. below the melting temperature of the stainless steel particles of the particulate build material to about 50° C. below the melting temperature of the stainless steel particles of the particulate build material. The sintering temperature can also depend upon a period of time that heating occurs, e.g., at a high temperature for a sufficient time to cause particle surfaces to become physically merged or composited together). The sintering temperature can sinter and/or otherwise fuse the stainless steel particles to form the sintered three-dimensional object.

In some examples, the method can further include preparing stainless steel particles for three-dimensional printing to form an oxidation barrier thereon, as described below.

### Methods of Preparing a Particulate Build Materials for Three-Dimensional Printing

Further presented herein is a method of preparing a build material for three-dimensional printing, as shown in FIG. 3. The method can include preheating stainless steel particles to a temperature ranging from about 150° C. to about 300° C. for a time period ranging from about 2 hours to about 15 hours to form an oxidation barrier on a surface of the stainless steel particles. In some examples, the preheating can be applied at a temperature ranging from about 150° C. to about 300° C., from about 150° C. to about 240° C., from about 150° C. to about 180° C., or from about 180° C. to about 280° C., for a time period that can range from about 2 hours to about 8 hours, from about 5 hours to about 15 hours, from about 2 hours to about 6 hours, from about 2 hours to about 4 hours, from about 6 hours to about 14 hours, or from about 4 hours to about 8 hours.

The preheating can occur in an oven prior to applying individual build material layers of the particulate build material onto a powder bed or can occur in the powder bed after the particulate build material has been applied thereto. In some examples, the preheating can occur at atmospheric pressure or at from about three-quarters of atmospheric pressure to atmospheric pressure.

The oxidation barrier formed on the stainless steel particles can be as described above and can act to prevent or minimize interactions of the core material of the stainless steel particles with outside chemicals.

### Three-Dimensional Printing Systems

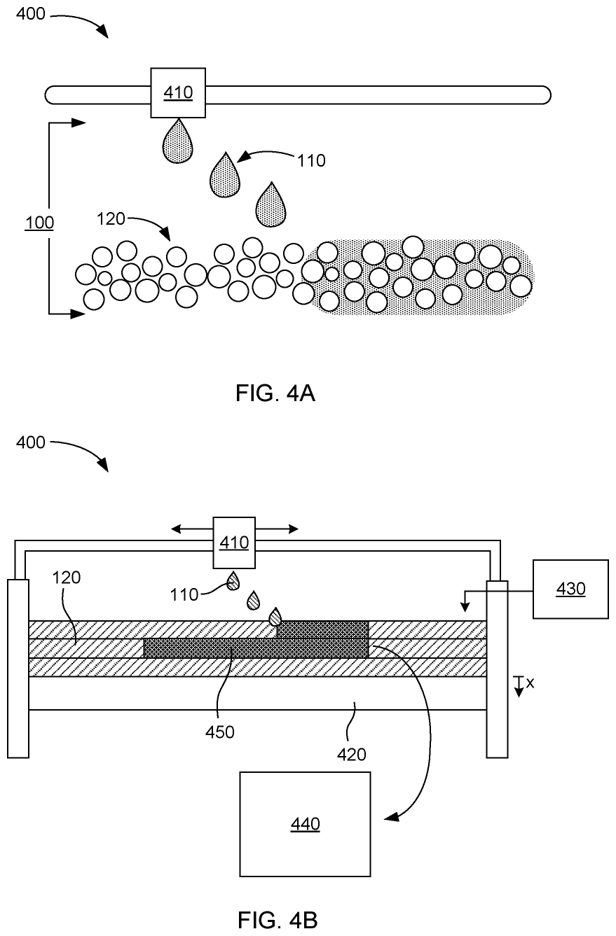

Also presented herein, is a three-dimensional printing system 400 as shown in FIGS. 4A and 4B. In an example, the three-dimensional printing system can include a three-dimensional printing kit 100 and a fluid applicator 410, as shown in FIG. 4A. The fluid applicator can be fluidly coupled or coupleable to the binding agent 110 of the three-dimensional printing kit and can be directable to apply the binding agent to the particulate build material 120 of the three-dimensional kit to form a layered green body object. The binding agent and the particulate build material can be as described in FIG. 1, for example. The binding agent and particulate build material can be as described above with respect to the three-dimensional printing kit. The fluid applicator, in further detail, can be any type of printing apparatus capable of selectively applying the binding agent. For example, the fluid applicator can be an inkjet printhead, a piezo-electric printhead, a thermal printhead, a continuous printhead, a sprayer, a dropper, or a combination thereof. Thus, in some examples, the application can be by jetting or ejecting from a digital fluid jet applicator, similar to an inkjet pen. In some examples, the fluid applicator can include a motor and can be operable to move back and forth over the particulate build material when positioned in a powder bed of a build platform.

In some examples, as further illustrated in FIG. 4B, the three-dimensional printing system can include, in addition to the fluid applicator and three-dimensional printing kit, e.g., the binding agent 110 and the particulate build material 120, a build platform 420 that can support a powder bed of particulate build material. The build platform can be positionable to receive the binding agent from the fluid applicator onto the particulate build material. The build platform can be configured to drop in height (shown at “x”), thus allowing for successive layers of particulate build material to be applied by a spreader 430. The particulate build material can be layered in the build platform at a thickness that can range from about 5 μm to about 1 cm. In some examples, individual layers can have a relatively uniform thickness. In one example, a thickness of a layer of the particulate build material can range from about 10 μm to about 500 μm. In another example, a thickness of a layer of the particulate build material can range from about 500 μm to about 1 cm. In further detail, the three-dimensional printing system can further include a fusing oven 440 to heat the green body object 450 (formed from the particulate build material with binding agent applied thereto) and to form a heat-fused three-dimensional object.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, the “green” is used to described any of a number of intermediate structures prior to any particle to particle material fusing, e.g., green part, green body, green body object, green body layer, etc. As a “green” structure, the particulate build material can be (weakly) bound together by a binder. Typically, a mechanical strength of the green body is such that the green body can be handled or extracted from a particulate build material on a build platform to place in a fusing oven, for example. It is to be understood that any particulate build material that is not patterned with the binding agent is not considered to be part of the “green” structure, even if the particulate build material is adjacent to or surrounds the green body object or layer thereof. For example, unprinted particulate build material can act to support the green body while contained therein, but the particulate build material is not part of the green structure unless the particulate build material is printed with a binding agent or some other fluid that is used to generate a solidified part prior to fusing, e.g., sintering, annealing, melting, etc.

As used herein, the terms “three-dimensional part,” “three-dimensional object,” or the like, refer to the target three-dimensional object that is being built. The three-dimensional object can be referred to as a “fused” or “sintered” three-dimensional object, indicating that the object has been fused such as by sintering, annealing, melting, etc., or a “green body” or “green” three-dimensional object, indicating the object has been solidified, but not fused.

As used herein, “kit” can be synonymous with and understood to include a plurality of compositions including multiple components where the different compositions can be separately contained in the same or multiple containers prior to and during use, e.g., building a three-dimensional object, but these components can be combined together during a build process. The containers can be any type of a vessel, box, or receptacle made of any material. Alternatively, a kit may be generated during the process of three-dimensional building a portion at a time. For example, the particulate build material can be steam treated at a time to form a “kit”, just prior to being printed thereon with the binding agent.

The term “fuse,” “fusing,” “fusion,” or the like refers to the joining of the material of adjacent particles of a particulate build material, such as by sintering, annealing, melting, or the like, and can include a complete fusing of adjacent particles into a common structure, e.g., melting together, or can include surface fusing where particles are not fully melted to a point of liquefaction, but which allow for individual particles of the particulate build material to become bound to one another, e.g., forming material bridges between particles at or near a point of contact.

As used herein, “applying” when referring to binding agent or other fluid agents that may be used, for example, refers to any technology that can be used to put or place the fluid agent, e.g., binding agent, on the particulate build material or into a layer of particulate build material for forming a three-dimensional green body object. For example, “applying” may refer to “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following is only illustrative of the application of the principles of the present disclosure. Numerous modifications and alternative ink compositions, ink sets, methods, etc., may be devised without departing from the scope of the present disclosure. The appended claims are intended to cover such modifications and arrangements.

### Example 1—Preparation of a Build Material for Three-Dimensional Printing

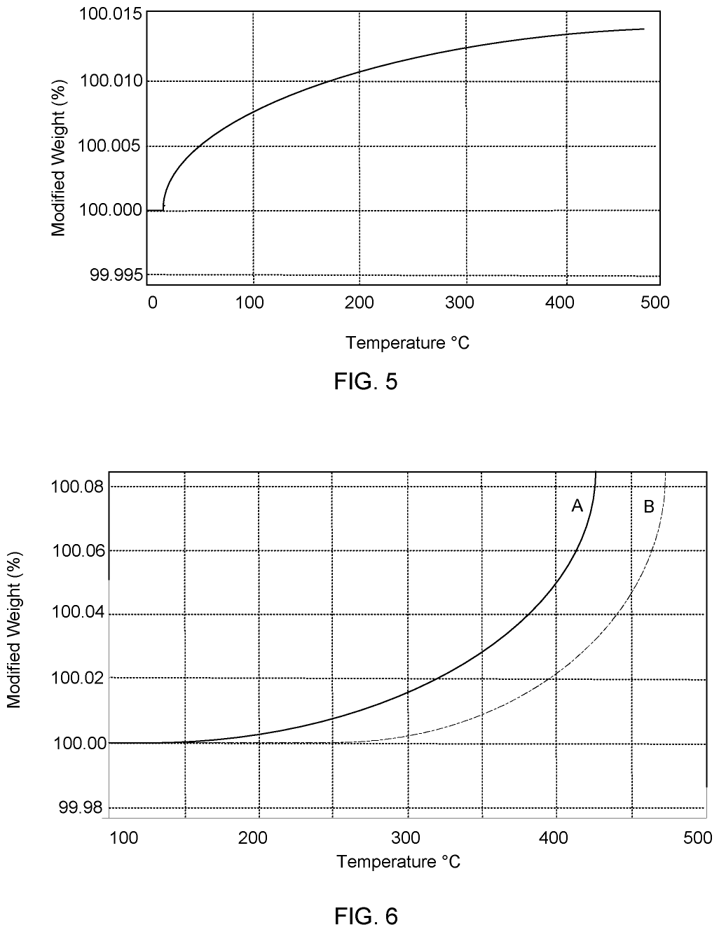

An oxidation barrier was formed on 22 μm stainless steel 316L particles by heating the particles in airflow at 180° C. for eight hours. A weight gain of the stainless steel particles was monitored during heating by a thermogravimetric analyzer (TGA). Weight gain was due to oxidation of the stainless steel particles in the atmosphere. A graph of the reactivity is shown in FIG. 5. An amount of the weight gain correlates to the formation of an oxide barrier layer on the stainless steel particles.

### Example 2—Reactivity Testing of Build Material

Stainless steel 316L particles with the oxidation barrier formed thereon as prepared in accordance with Example 1, where compared to 22 μm control stainless steel 316L particles which were not heated. The control stainless steel 316L particles had a native oxide layer formed thereon based on interactions with atmospheric oxygen. To assess reactivity of these build materials, the stainless steel 316L particles with the oxidation barrier formed thereon and the control stainless steel 316L particles were gradually heated at 10° C. per minute in an oxidizing air atmosphere. Weight gain of the build materials was monitored during heating, as indicated in Example 1. Weight gain can be correlated to a reactivity of the stainless steel particles. A graph of the reactivity is shown in FIG. 6. As indicated in FIG. 6, the control stainless steel 316L particles (A) began gaining weight at a temperature of 143.02° C. The stainless steel 316L particles with the oxidation barrier formed thereon (B) began gaining weight at a temperature of 257.39° C. The differences in temperatures at which the build materials gained weight indicates that the stainless steel 316L particles with the oxidation barrier formed thereon were less reactive than the control stainless steel particles.

### Example 3—Reactivity Testing with an Organic Co-Solvent

Stainless steel 316L particles were heated in airflow at 180° C. for two and half hours to form oxidation barrier thereon. These particles, as well as control stainless steel particles which were not heated, were respectively placed in vials containing 1 mL of 1,2-butanediol for 8 hours at 180° C. The stainless steel 316L particles with the oxidation barrier formed thereon formed minor amounts of small powder cakes following evaporation of the 1,2-butanediol. A total weight of this material was about 4-5 times a total of the stainless steel 316L particles with the oxidation barrier formed thereon that were placed in the vial. The control stainless steel particles formed large powder cakes following evaporation of the 1,2-butanediol. The large powder cakes formed were about 1.5 times a total weight of the control stainless steel particles placed in the vial. In addition, the small powder cakes exhibited lower overall strength and were easier to disperse than the large powder cakes formed by the control stainless steel particles. The oxidation barrier on the stainless steel particles minimized interactions between the particles and vapors from the evaporating 1,2-butanediol, thereby minimizing an amount and size of powder cakes formed.

What is claimed is:

1. A three-dimensional printing kit comprising:
a binding agent including a binder dispersed in an aqueous liquid vehicle, wherein the aqueous liquid vehicle includes an organic co-solvent with a boiling point from about 150° C. to about 300° C.; and
a particulate build material including from about 80 wt % to 100 wt % stainless steel particles having an average particle size from about 3 μm to about 200 μm, wherein from about 0.02 wt % to about 0.3 wt % of a total weight of the stainless steel particles is an oxidation barrier formed on surfaces of the stainless steel particles.

2. The three-dimensional printing kit of claim 1, wherein the organic co-solvent is a polyol, an oligoglycol, or a lactam.

3. The three-dimensional printing kit of claim 1, wherein the organic co-solvent is selected from diols; 1,2 butanediol; 1,2-propanediol; 2,3-butanediol; 1,2-pentanediol; 2-methyl-2,4-pentanediol; 2-methyl-1,3-propanediol; triols; tetrahydrofuran; ethylene glycol dimethyl ether; ethylene glycol diethylene glycol; triethylene glycol; propylene glycol; tripropylene glycol butyl ether; lactams; 2-pyrrolidone; 1-(2-hydroxyethyl)-2-pyrrolidone; or a combination thereof.

4. The three-dimensional printing kit of claim 1, wherein the organic co-solvent is present in the aqueous liquid vehicle at from about 5 wt % to about 50 wt %.

5. The three-dimensional printing kit of claim 1, wherein the stainless steel particles are austenitic stainless steel particles.

6. The three-dimensional printing kit of claim 1, wherein a carbon content of the stainless steel particles is from about 0.001 wt % to about 0.1 wt %.

7. The three-dimensional printing kit of claim 1, wherein the oxidation barrier is a layer formed from Fe₂O₃, Fe₃O₄FeO, Cr₂O₃, Ni₂O₃, Mn₂O₃, oxides, complex oxides, or a combination thereof on a core of the stainless steel particles.

8. The three-dimensional printing kit of claim 1, wherein the oxidation barrier has an average thickness of from about 3 nm to about 30 nm.

9. A method of three-dimensional printing comprising:
iteratively applying individual build material layers of a particulate build material onto a powder bed, the particulate build material including from about 80 wt % to 100 wt % stainless steel particles having an average particle size from about 3 μm to about 200 μm, wherein from about 0.02 wt % to about 0.3 wt % of a total weight of the stainless steel particles is an oxidation barrier formed on surfaces of the stainless steel particles; and
based on a three-dimensional object model, iteratively and selectively applying a binding agent to the individual build material layers to define individually patterned object layers that become adhered to one another to form a layered green body object, the binding agent including a binder dispersed in an aqueous liquid vehicle, wherein the aqueous liquid vehicle includes an organic co-solvent with a boiling point ranging from about 150° C. to about 300° C.

10. The method of claim 9, further comprising preheating stainless steel particles to a temperature ranging from about 150° C. to about 300° C. for a time period ranging from about 2 hours to about 15 hours to form the oxidation barrier on the stainless steel particles.

11. The method of claim 9, further comprising heating the layered green body object to a temperature from about 600° C. to about 1,500° C. to fuse the layered green body object together and form a fused three-dimensional object.

12. The method of claim 9, wherein the organic co-solvent includes 1,2 butanediol.

13. The method of claim 9, wherein the oxidation barrier has an average thickness of from about 3 nm to about 30 nm.

14. A method of preparing a build material for three-dimensional printing comprising heating stainless steel particles to a temperature ranging from about 150° C. to about 300° C. for a time period ranging from about 2 hours to about 15 hours to form an oxidation barrier on the stainless steel particles.

15. The method of claim 14, wherein the oxidation barrier formed on the stainless steel particles is from about 0.02 wt % to 0.3 wt % of a total weight of the stainless steel particles.
